(19) United States
(12) Patent Application Publication
(10) Pub. No.: US 2008/0126136 A1
(43) Pub. Date: May 29, 2008

(54) Method and system for insuring against loss in connection with an online financial transaction

(75) Inventor: Robert J. Nighan, Wethersfield, CT (US)

Correspondence Address: WILMERHALE/NEW YORK, 399 PARK AVENUE, NEW YORK, NY, 10022, US

(73) Assignee: Travelers Property Casualty Corp., Hartford, CT (US)

(21) Appl. No.: 11/489,266

(22) Filed: Jul. 18, 2006

Related U.S. Application Data
(63) Continuation of application No. 09/877,939, filed on Jun. 8, 2001, now abandoned.
(60) Provisional application No. 60/211,557, filed on Jun. 15, 2000.
(60) Provisional application No. 60/214,302, filed on Jun. 27, 2000.

(51) Int. Cl. G06Q 40/00

(52) U.S. Cl. 705/4

(57) ABSTRACT

A method and system for insuring a consumer against a loss incurred in connection with an online financial transaction service which loss occurs in the consumer's account and for which the consumer would normally have liability under applicable banking regulations, as well as losses from fees, such as returned check fees, resulting from such unauthorized transactions. In addition to losses involving unauthorized transactions within traditional internet banking services offered commonly by banking institutions, covered losses include, for example, a loss involving a funds transfer service provider which is given access to the consumer's account by the online consumer as part of a bill management service, a loss involving an account aggregation service provider which is given access to the consumer's account by the online consumer as part of an account aggregation service, as well as a loss incurred in connection with an online financial transaction involving a person to person payment service.

### PRIORITY APPLICATION

This application is a continuation of U.S. application Ser. No. 09/877,939, filed Jun. 8, 2001, which claims the benefit of U.S. Provisional Application No. 60/211,557, filed Jun. 15, 2000, entitled “Method and System for Insuring Against Loss in Connection With an Online Financial Transaction (SafeWeb)” and U.S. Provisional Application No. 60/214,302, filed Jun. 27, 2000, entitled “Method and System for Insuring Against Loss in Connection With an Online Financial Transaction (SafeWeb)”, each of which are incorporated herein by this reference.

### FIELD OF THE INVENTION

The present invention relates generally to the field of electronic commerce, and more particularly to a method and system for insuring a consumer, who is the end-user that is using an online service of an entity that is the insurer's client, against a loss incurred in connection with an online financial transaction.

### BACKGROUND OF THE INVENTION

With the recent spread in use of the home personal computer, many financial institutions have begun providing a service that allows their customers to access personal accounts through personal computers. These financial institutions allow their customers to pay bills, transfer funds, determine current account balances, and perform other banking functions without having to visit the financial institution. The concept of remote banking refers to services offered by banks which allow individual customers the ability to initiate banking transactions, such as bill payments, from home or anywhere else by personal computer or wireless electronic device operation over phone or cable lines or wireless service. These systems may or may not utilize the Internet. The term “remote banking” is the current term of choice in the industry over “home banking” given the ability of lap top computers or wireless electronic devices to allow online banking consumers to access their accounts from any remote location.

Under applicable banking regulations, home or remote banking consumers can be liable for unauthorized transactions in their online accounts. The extent of a consumer's liability is determined solely by their promptness in reporting the loss of their PIN or an unauthorized transaction appearing in their monthly statement. In certain circumstances, a consumer can have unlimited liability for an unauthorized transaction in their online account. Also, the online consumer can be liable for bounced check fees due to an unauthorized transaction causing them to have insufficient funds. Currently, to address online security, virtually all online banking websites provide a security page section. These security pages detail the measures in place to prevent or detect online unauthorized transactions loss from happening, such as access codes, timeout features, secure browser, firewalls and activity logs. However, these common online security features offer no assurance for the potential online customer regarding how they would be protected if an unauthorized transaction does occur.

The vast majority of U.S. consumers with online access do not currently use online banking services, and wariness of web security is an important concern for those considering banking online. A major problem for electronic commerce today is how to address this consumer concern over the security of using the Internet for financial transactions. From the time when the Internet first began to be used for financial transactions, the concern that using the Internet for financial transactions was not safe, for example, from hacker break-ins, has been reported extensively in the media. Financial institutions and others have tried to address this concern through constantly increasing security, which has gone from a lower level of encryption up to a 128-bit encryption. While measures, such as using security, may help to reduce the risk of a loss occurring, there is currently no mechanism in place to deal with a situation in which the security fails and a loss occurs. There is a present need for a mechanism which goes beyond security and affords a guarantee of protection that stands behind security as a safety net and ensure consumer confidence in the safety of online financial transactions.

### SUMMARY OF THE INVENTION

It is a feature and advantage of the present invention to provide a method and system for insuring a consumer against a loss incurred in connection with an online financial transaction, which affords the consumer a guarantee of protection that stands behind Internet security as a safety net and addresses security issues in a unique way that gives consumers a level of comfort in performing Internet financial transactions.

It is another feature and advantage of the present invention to provide a method and system for insuring a consumer against loss from unauthorized transactions that occur in the consumer's account and for which the consumer would normally have liability under applicable banking regulations.

It is an additional feature and advantage of the present invention to provide a method and system for insuring a consumer against a loss from fees, such as returned check fees, resulting from such unauthorized transactions.

It is a further feature and advantage of the present invention to provide a method and system for insuring a consumer against a loss incurred in connection with an online financial transaction, which affords a number of unique advertising and marketing opportunities to the financial institution.

It is another feature and advantage of the present invention to provide a method and system for insuring a consumer against a loss incurred in connection with an online financial transaction involving a funds transfer service provider which is not the accountholder but which has been given access, for example, by the online consumer as part of a bill management service.

It is another feature and advantage of the present invention to provide a method and system for insuring a consumer against a loss incurred in connection with an online financial transaction involving an online account aggregation service that allows the consumer online access to multiple online accounts of the consumer via the account aggregation service's website.

It is still another feature and advantage of the present invention to provide a method and system for insuring a consumer that is using a service protected by the present invention against expenses as a result of identity theft.

It is a still further feature and advantage of the present invention to provide a method and system for insuring a consumer against a loss incurred in connection with an online financial transaction involving a person to person payment service.

To achieve the stated and other features, advantages and objects, an embodiment of the present invention provides a method and system for insuring a consumer against a loss incurred in connection with an online financial transaction, such as a loss that occurs in the consumer's account and for which the consumer would normally have liability under applicable banking regulations, as well as losses from fees, such as returned check fees, resulting from such unauthorized transactions. Another aspect of the method and system for an embodiment of the present invention includes, for example, insuring the consumer against such a loss involving a funds transfer service provider which is not the accountholder but which has been given access by the online consumer as part of a bill management service. Yet another aspect of the method and system for an embodiment of the present invention includes, for example, insuring the consumer against such a loss involving an online account aggregation service which may or may not be an account holder and which allows the consumer online access to multiple online accounts of the consumer via the online account aggregation service's website.

Other aspects of the method and system for an embodiment of the present invention include, for example, insuring the online consumer against expenses incurred as a result of identity theft, as well as a loss incurred in connection with an online financial transaction involving a person to person payment service. An additional aspect of the method and system for an embodiment of the present invention involves the use of either or both of manual processes and computer hardware and software processes in insuring the online consumer against such losses and expenses.

The present invention provides a method and system for insuring a consumer against loss resulting from unauthorized transactions in connection with use by the consumer of an online financial transaction service. In an embodiment of the present invention, a requirement is received, for example, by an underwriter from a provider of online transaction services, for a policy structure for a master insurance policy that provides coverage for loss relating to use by the consumer of one or more online financial transaction services provided by the service provider, such as an online banking service, online account aggregation service, and online bill management service, and/or an online person to person payment service.

A plurality of account categories are defined, for example, by the underwriter, that have an associated risk of loss for the consumer resulting from an unauthorized transaction relating to the online financial transaction service, such as a banking account of the consumer capable of online transactions, an account of the consumer to which an online finds transfer service provider is given access by the consumer as part of a bill management service, an account(s) of the consumer to which an account aggregation service is given access by the consumer as part of an account aggregation service, and/or an account of the consumer from which an online payment service provider is authorized by the consumer to make payments, for which loss the consumer would normally have responsibility under applicable banking regulations that is imposed, for example in tiers, such as a $50 tier, a $500 tier, and an unlimited tier of consumer liability.

One or more of the defined account categories are ascertained, for example, by the underwriter that correspond to the requirement for the policy structure for the master insurance policy, such the banking account of the consumer capable of online transactions, the account of the consumer to which an online funds transfer service provider is given access by the consumer as part of a bill management service, an account(s) of the consumer to which an account aggregation service is given access by the consumer as part of an account aggregation service, and/or the account of the consumer from which an online payment service provider is authorized by the consumer to make payments. An online financial transaction coverage for the defined account category that corresponds to the policy structure of the master insurance policy is inserted that includes, for example, coverage for loss resulting from unauthorized transactions in the account for which the consumer would normally have liability under applicable banking regulations, coverage for expenses, such as returned check fees, incurred by the consumer as a result of a covered unauthorized transaction in the account for which the consumer would normally have liability under applicable banking regulations, and/or coverage for expense incurred by the online consumer as the direct result of an identity fraud.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a table which illustrates examples of the types of protection provided by coverage under the policy utilized for an embodiment of the present invention;

FIG. 2 is a schematic diagram with illustrates an example overview of key components and the flow of information between the key components for Internet banking covered under the policy utilized for an embodiment of the present invention;

FIG. 3 is a table which illustrates examples of the types of losses covered under the insuring agreements of the policy utilized for an embodiment of the present invention;

FIG. 4 is a table which illustrates examples of tiers of consumer liability imposed under Regulation E;

FIG. 5 is a table which illustrates an example of the steps by which a customer's liability for electronic financial transactions losses increases, defined by the customer's promptness in reporting the loss, according to Regulation E;

FIG. 6 is a schematic diagram which illustrates an example overview of key components and the flow of information between key components for an Internet bill management service covered under the policy utilized for an embodiment of the present invention;

FIG. 7 is a schematic diagram which illustrates an example overview of key components and the flow of information between key components for an online account aggregation service covered under the policy utilized for an embodiment of the present invention.

FIG. 8 is a schematic diagram which illustrates an example overview of key components and the flow of information between key components for online person to person payment service covered under the policy utilized for an embodiment of the present invention; and

FIG. 9 is a flow chart which illustrates an example of the process of insuring against loss resulting from unauthorized transactions in connection with the use by a consumer of an online service that provides online financial transactions, according to the method and system for an embodiment of the present invention.

### DETAILED DESCRIPTION

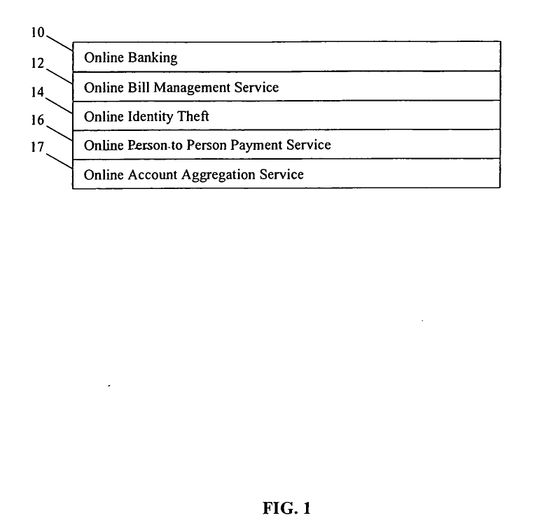

Referring now in detail to an embodiment of the invention, an example of which is illustrated in the accompanying drawings, FIG. 1 is a table which illustrates examples of the types of protection provided by coverage under the policy utilized for an embodiment of the present invention, which include, for example online banking 10, online bill management service 12, online identity theft 14, online person to person payment service 16, and online account aggregation service 17. An embodiment of the present invention provides a solution that goes beyond Internet security and affords a guarantee of protection as a safety net that utilizes a master policy written, for example, with a financial institution, such as an Internet bank. A single policy is written for the Internet bank for a predetermined term, such as an annual term, and the coverage under the policy applies automatically to any individual that does online banking with the Internet bank, or which individual becomes a customer of the Internet Bank during the policy's term.

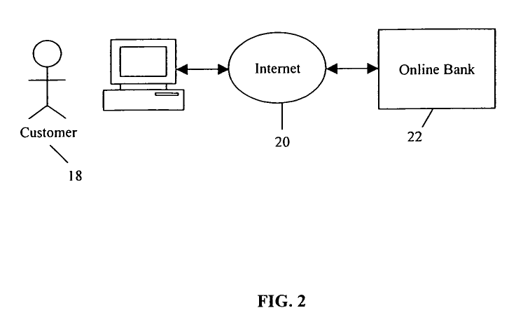

FIG. 2 is a schematic diagram with illustrates an example overview of key components and the flow of information between the key components for Internet banking covered under the policy utilized for an embodiment of the present invention. The coverage under the policy for an embodiment of the present invention provides protection against unauthorized transactions that occur in a customer's account and for which the customer 18 would normally have liability under applicable banking regulations, such as Regulation E, Electronic Funds Transfers (12 CFR 205, as amended effective May 1, 1996), issued by the Board of Governors of the Federal Reserve System pursuant to the Electronic Funds Transfer Act enacted in 1978. Regulation E spells out who is responsible when an unauthorized transaction occurs and specifies whether the financial institution 22 must make the customer 18 whole or the customer 18 is responsible. The policy addresses those circumstances in which the customer 18 would normally have responsibility for the unauthorized transaction.

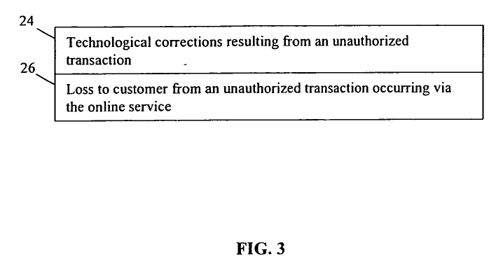

Regulation E provides a framework of establishing the rights, liabilities and responsibilities of participants in electronic funds transfer systems. Types of transfers covered by the Act include home or remote banking programs 10. Regulation E provides rules that govern the limitations on consumer liability for unauthorized transactions under such remote banking programs 10. The insurance policy utilized for an embodiment of the present invention contains typically two insuring agreements. FIG. 3 is a table which illustrates examples of the types of losses covered under the insuring agreements of the policy utilized for an embodiment of the present invention. A first insuring agreement 24 provides coverage to the financial institution 22 for the resulting technological corrections required in the event of unauthorized access to the customer's accounts. A second insuring agreement 26 provides, depending on policy version, either coverage to the financial institution 22 for making restitution to a customer 18, or coverage directly to the customer 18, for loss resulting from an unauthorized transaction in an account maintained by the customer 18. The second insuring agreement 26 is modeled after Regulation E and is intended to cover circumstances where a remote banking consumer would have liability for unauthorized transactions under Regulation E.

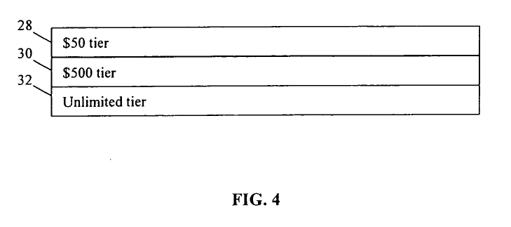

Under Regulation E, the extent of a consumer's liability is determined solely by the consumer's promptness in reporting the loss or theft of their access device (PIN) or reporting an unauthorized transaction that appears in a monthly statement. FIG. 4 is a table which illustrates examples of tiers of consumer liability imposed under Regulation E. There are three tiers of consumer liability imposed under Regulation E, Section 205.6, including a $50 tier 28, a $500 tier 30 and an unlimited tier 32. Under Regulation E, Section 205.6, a consumer's liability for unauthorized transactions is tied directly to their promptness in reporting the loss or theft of their access device (PIN) or reporting an unauthorized transaction that appears in a monthly statement. The bank's or service provider's consumer agreement, terms and conditions, terms of use, or similarly named document for their online service must contain a disclosure of the consumer's responsibility for unauthorized transactions. The first two tiers of Regulation E, the $50 tier 28 and the $500 tier 30, deal with unauthorized transactions resulting from the loss of the consumer's access device, such as their PIN or password that they use to access their online account.

The third tier of Regulation E, the unlimited liability tier 32, deals with an unauthorized transaction that appears in a monthly statement. Losses under the third tier 32 may or may not involve loss by the customer 18 of their access device. However, if an unauthorized transaction has nothing to do with loss by the customer 18 of their access device, such as a hacker gaining access to their account, then only the rules and conditions for the third tier 32 apply. A key theme of Regulation E is that the $50 tier 28 and $500 tier 30 deal solely with losses resulting from loss by the customer 18 of their access device, while the unlimited tier 32 deals solely with unauthorized transactions that appear in a periodic statement. In the context of Internet banking, consumers are unlikely to frequently carry their access device with them and risk having it lost or stolen. Therefore, a primary risk of liability for the customer 18 against which the policy utilized for an embodiment of the present invention can provide protection is the unlimited liability tier 32.

The method and system for an embodiment of the present invention provides a policy that is both clear and brief and that has the remedial action expense insuring agreement 24, which provides coverage only to the bank or service provider 22, and the unauthorized remote banking electronic funds transfer insuring agreement 26, which provides coverage ultimately to the insured person, which is the customer 18. The insured person is defined under the policy as an individual remote banking customer. The remedial action expense insuring agreement 24 provides coverage to the bank or service provider 22 for the costs of bringing in outside computer programmers to identify and correct the cause of a paid loss under the unauthorized remote banking electronic funds transfer insuring agreement 26. The remedial action expense insuring agreement 24 only provides coverage if there is a paid loss under the unauthorized remote banking electronic funds transfer insuring agreement 26. Prior written consent of the underwriter is mandatory before such costs can be incurred, if the bank or service provider 22 wishes them covered.

The unauthorized remote banking electronic funds transfer insuring agreement 26 is an important feature of the policy utilized for an embodiment of the present invention. Coverage is provided for loss of money and also for both overdraft fees and loss of interest income that arise from an unauthorized transaction. A primary loss situation covered under the unauthorized remote banking electronic funds transfer insuring agreement 26, for example, is a hacker gaining entry to the remote banking system, successfully posing as a customer of the bank 22, and carrying out unauthorized transactions, such as initiation of bill payments to bogus recipients, from the customer's account. Another loss situation covered under the unauthorized remote banking electronic funds transfer insuring agreement 26 is a situation where someone unrelated to the insured person, such as a burglar, gains access to the insured person's PC and is able to send instructions for unauthorized bill payments. Unauthorized bill payment is a most likely way to cause a loss under a remote banking system, as it is the primary way to move money out of a customer's account with a remote banking system.

The method and system for an embodiment of the present invention utilizes, for example, a master policy approach, covering all remote banking customers against loss resulting from unauthorized transactions in their online banking accounts that the customers may be liable for under applicable banking regulations. The coverage can be written on a master policy basis, with the online bank 22 being named in the master policy as the Master Policy Holder and the bank's customer being the Insured Persons under the Master Policy. The policy can be adapted by endorsement to allow the bank 22 to offer coverage as an option to their home banking customers. Covered losses include not only loss of money by the remote banking consumer, but also overdraft fees incurred by the consumer as a result of insufficient funds and loss of interest income in the consumer's account, resulting from a covered unauthorized transaction. Limit of liability applies, for example, per customer, per loss, with no aggregate limitations and with no deductible applied to the consumer protection under the Master Policy. The expense reimbursement coverage 24 can be made available to pay for costs incurred by the bank 22 to hire computer programmers to identify and correct the cause of a loss.

The policy for an embodiment of the present invention is designed to follow applicable banking regulations and terminology. Thus, coverage is only for remote banking customers that are natural persons, as Regulation E defines a consumer as a natural person and defines an account as one primarily for personal, family or household purposes. No coverage is provided for loss caused, for example, by a relative of the remote banking customer 18 or for loss arising from voluntary surrendering of a password by the remote banking customer 18. Further, no coverage is provided for loss caused by a dishonest act of a bank employee, as Regulation E does not impose liability on the remote banking customer 18 for such a loss. In considering how coverage is triggered, it must be kept in mind that the policy provides coverage for an insured person's Regulation E liability and certain resulting expenses. Thus, the bank 22 or applicable service provider must make a determination, as it normally would, of what liability, if any, the customer 18 has for an unauthorized transaction under Regulation E. If such determination results in liability to the customer 18 under Regulation E, then coverage under the unauthorized remote banking electronic funds transfer insuring agreement 26 is triggered, subject to policy conditions.

Under the policy utilized for an embodiment of the present invention, the insured person 18 is required to notify the bank 22 of an unauthorized transaction after discovery. The insured person 18 must give notice to the underwriter within 30 days after notifying the bank 22. The bank 22 then reviews the circumstances to determine if the insured person 18 has any liability under Regulation E. If the bank 22 does in fact determine that the insured person 18 has liability, then the insured person 18 files a proof of loss with the underwriter. Inasmuch as both the FBI and the U.S. Secret Service have jurisdiction over computer crimes, it is possible that either or both of these federal agencies could become involved with the insured person 18 and the bank 22 in the investigation of an unauthorized transaction in a remote banking system. From the underwriter's perspective, the involvement of these agencies is positive, as insured persons may be less likely to pursue fraudulent claims in the presence of such federal law enforcement agencies.

Regulation E provides a framework of establishing the rights, liabilities and responsibilities of participants in electronic funds transfer systems. Types of transfers covered by the Act includes online banking services 22. Regulation E provides rules that govern the limitations on consumer 18 liability for unauthorized transactions under such online banking services 22.

The master policy is intended to cover circumstances where a remote banking consumer 18 would have liability for unauthorized transactions under Regulation E. Under Regulation E, the extent of a consumer's 18 liability is determined solely by the consumer's 18 promptness in reporting the loss or theft of their access device (e.g., an online banking PIN code) to their bank 22 or reporting an unauthorized transaction that appears in a monthly statement. And therefore, the insured exposure to insured loss under the master policy is similarly tied to such promptness. If the consumer 18 is not responsible for the unauthorized transaction under the terms of Regulation E, then the bank 22 or similar service provider is responsible for making the customer 18 whole for that loss.

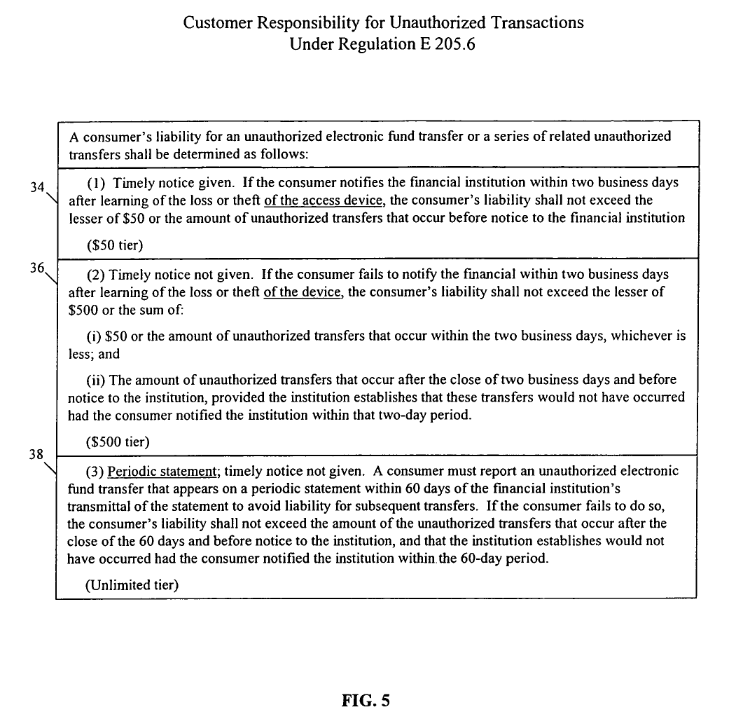

As shown in FIG. 5, the first two tiers of Regulation E—the $50 tier 34 and the $500 tier 36—deal with unauthorized transactions resulting from the loss of the consumer's 18 access device (i.e., their PIN or password that they use to access their online account via the online banking service 22). The third tier 38 of Regulation E (unlimited liability) deals with an unauthorized transaction that appears in a monthly statement. Losses under the third tier may or may not involve loss by the customer of their access device. However, if an unauthorized transaction has nothing to do with loss by the customer of their access device (e.g., a hacker gains access to their account), then only the third tier's rules and conditions apply. In the context of internet banking, as consumers 18 aren't too likely to frequently carry their access device with them (and risk having it lost or stolen), the primary exposure under the Master Policy is the third tier of unlimited liability.

The following text provides examples of the three tiers of consumer 18 responsibility under Regulation E:

If the customer 18 notifies the bank 22 within two business days after the customer 18 learns that his/her PIN may have become known by an unauthorized person, the customer 18 can lose no more than $50.00 (first tier 34) if an unauthorized person uses that PIN without permission to initiate a transaction. If the customer 18 does not notify the bank 22 within two business days, and the bank 22 can prove that the customer could have stopped someone from using the customer's 18 PIN without the customer's 18 permission if the customer 18 had told the bank 22, the customer 18 could be liable for as much as $500.00 (second tier 36).

Also, if the customer's 18 periodic statement shows electronic funds transfers that the customer did not make or authorize, the customer 18 should notify the bank 22 at once. If the customer 18 does not notify the bank 22 within 60 days after the periodic statement was mailed to the customer 18, you may not recover any money you lose (third tier 38) after the 60 days if the bank 22 can prove that the bank 22 could have stopped someone from taking the money if the customer 18 had notified the bank 22 on time. If a good reason (such as a long trip or hospital stay) kept the customer 18 from notifying the bank 22, the bank 22 may extend the time periods.

Customers 18 sometimes mistakenly believe that their liability for unauthorized transactions via their online banking service is capped at $50 as is the case with credit cards. However, online banking and similar funds transfer services fall to Regulation E which imposes the above responsibilities and exposures on the customer 18, and is the reason for the importance of the Master Policy.

In addition to covering the money stolen via an unauthorized transaction, the policy utilized for an embodiment of the present invention also provides for reimbursement of the customer 18 for resulting fees. For example, if money is taken from a customer's account in an unauthorized transaction, the funds remaining in the account may be insufficient to cover outstanding checks written by the customer 18. In that event, the checks may be returned, and returned check fees may be imposed by each of a number of merchants. The policy covers those returned check fees as well. The protection includes overdraft fees and loss of interest incurred by the customer 18 until he or she is made whole, subject to policy conditions and coverage limit.

An embodiment of the present invention includes several options for the arranging protection, such as blanket coverage for the bank's entire online banking customer base, coverage at different dollar amounts for different customer 18 status levels at the bank, or coverage at different dollar amounts for different service levels offered by the bank 22. The bank 22 pays the premium for the master policy as a benefit to the customer 18; however, in some states it is possible that the bank could either charge the customer for the coverage or offer it as an option that the customer elects to buy. Further, the coverage of the policy for an embodiment of the present invention applies separately to every single customer that is an Internet banking customer, with no aggregate limitation. Thus, a financial institution, such as the Internet bank 22, with which the policy is written can advertise to its customers that they are afforded, for example, protection of $100,000 under the policy and that the protection is separate to every customer with no deductible.

The particular form of the policy for an embodiment of the present invention may vary in some states because of local requirements. In one aspect of an embodiment of the present invention, if allowed by local requirements, the underwriter of the policy actually issues checks directly to customers of the online bank 22 in settlement of claims under the policy. In another aspect of an embodiment of the present invention, if local requirements restrict the extent to which the underwriter of the policy is allowed to deal directly with customers of the online bank 22, the checks are issued to the online bank 22 as reimbursement for restitution made to the customers by the online bank 22. The reimbursement aspect can provide a marketing advantage in that the online bank 22 may consider it a benefit that its customers only have to deal with the online bank 22.

The coverage of the policy utilized for an embodiment of the present invention provides many benefits for the online banking service 22. For example, the protection of the policy, when promoted within the security section of the online banking website, increases consumer confidence in the online banking service 22 by greatly reducing the security concerns and leads to increased usage. Further, the protection afforded by the coverage can be a point of difference from competing online banking programs, as the coverage can be advertised as a feature of the online banking service 22, also leading to increased usage. Additionally, the coverage afforded by the policy provides an important marketing benefit from the financial institution's perspective, in that the financial institution 22 procures insurance that is not for its own protection, but rather for its customers' protection with the coverage afforded by the policy acting as a safety net that stands behind the bank's security controls.

The financial institution 22 can advertise the protection afforded by the policy utilized for an embodiment of the present invention heavily to its customers and potential customers, for example, on its web site. An aspect of an embodiment of the present invention includes, for example, a link on the financial institution's homepage that advertises the protection as provided by the particular underwriter. A visitor to the financial institution's web site can click on the link and open a page within the web site to display, for example, materials written and provided by the underwriter to the financial institution 22 describing all of the benefits of the coverage and emphasizing that the coverage is unique and does not cost the customer 18 anything, but is simply a benefit of using the particular online banking service 22.

An embodiment of the present invention provides a unique approach to the issue of addressing consumer concerns over Internet security. In the past, the only way in which Internet security was addressed was with greater and greater levels of security, such as stronger firewalls, more password requirements, heavier levels of encryption, and the like. However, those measures did not provide a guarantee of protection, such as provided by the policy utilized for an embodiment of the present invention. Moreover, the guarantee of protection is provided by a third party, such as a large reputable insurance company that is in the business of paying claims, which is very likely to be a better guarantee than a guarantee from the financial institution 22, because of the size and the strength of the insurance company. Further, because the insurance company is in the business of paying claims and making people whole, its infrastructure for taking care of customers in that regard is better than that of a financial institution.

Another aspect of an embodiment of the present invention involves, for example, a funds transfer service provider that is not the accountholder, which is dealt with in a special section within Regulation E. Section 205.14 of Regulation E is a special section for electronic fund transfer service providers not holding a consumer's account. The policy utilized for an embodiment of the present invention provides programs for this type of account, as well. An example of this type of account is an Internet bill management service for consumers. The consumer agreement for such a bill management service differs in that the Regulation E disclosure extends the time period for notice of loss or theft of an access device from two business days to four business days, and also extends the time period for reporting unauthorized transactions that appear in the periodic statement from 60 days to 90 days.

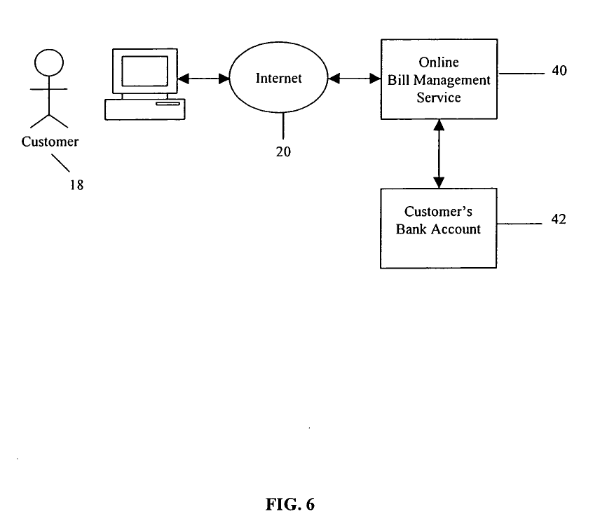

FIG. 6 is a schematic diagram which illustrates an example overview of key components and the flow of information between key components for an Internet bill management service covered under the policy utilized for an embodiment of the present invention. The online personal bill management service 40 requires consumers to instruct their creditors and service providers to start sending their bills to the bill management service 40 instead of to the consumer's home or office. When the bill management service 40 receives the bills, it notifies the customers via email. Customers then log on to their account with the bill management service 40, view the bills and issue instructions on when and how much to pay. The bill management service 40 then debits the appropriate amount of money from the customer's bank account 42 to make the payments. Customers can also automate payments, eliminating the need for looking at a particular bill each month and proactively authorizing its payment.

The online personal bill management service 40 allows customers to securely view and pay all their bills via the Internet 20. The bill management service 40 essentially concentrates all of the bill-related tasks of the customer 18 with one service provider that uses computers to keep track of the bills and pay them. The bill management service 40 hinges on the willingness of the customer 18 to trust the Internet 20, and a relatively unknown third party service provider, with personal information describing the consumer's consumption habits. For example, customers have their bills sent to the bill management service provider, which scans the bills and sends the customer 18 an e-mail with a photograph of the bills, and the customer 18 can simply click whether to pay or not. The target audience for such a bill management service, in particular, is business travelers who are not often at home. Instead of having bills pile up at the customer's home, the customer 18 can simply check his or her e-mail and see what bills are there and pay them. Alternatively, the customer 18 can pre-arrange to pay his or her bills automatically.

An embodiment of the present invention provides a unique way for funds transfer service providers, such as a bill management service 40, to address security issues to make people feel comfortable about performing Internet financial transactions. Thus, in an embodiment of the present invention, a policy can be written with a funds transfer service 40, for example, by amending a policy written with an online bank 22, by focusing on how a particular funds transfer service 40 works for its customers. For example, in a policy written with an online bank, it is contemplated that an online customer 22 has an account with the financial institution (or with the master policyholder). However, in a policy written with a funds transfer service 40, the definition of the term “account” includes an account 42 held at a financial institution to which the funds transfer service 40 has been given access by the online customer 18 as part of the bill management service 40.

Under the bill management service policy utilized for an embodiment of the present invention, an insured person includes any natural person who maintains an account, established at a financial institution primarily for personal, family or household purposes, and to which the master policy holder (in this case, the bill management service) is granted access by the customer (insured person) as part of the bill management service arrangement between the insured person and the master policy holder. In addition, for the bill management service policy, a remote banking communication system is any electronic system provided by the master policy holder for use by an insured person which allows the insured person to send instructions via a personal computer operating through telephone or similar communication lines to the master policy holder for the purpose of allowing the insured person to transfer money to or from an account, or to pay bills electronically from a remote location.

Another aspect of an embodiment of the present invention involves, for example, an online account aggregation service which—in particular similarity to the Internet bill management service described above—is not necessarily the account holder. An online account aggregation service allows the consumer online access to multiple online accounts of the consumer via the account aggregation service's website, with the benefit being that the consumer can view in one location their multiple online accounts. Such accounts that the consumer may elect to aggregate via the online account aggregation service may include online banking and brokerage accounts held at different institutions, as well as non-financial accounts such as email or travel planning services. Unauthorized transactions via the account aggregation service into the customers funds transfer enabled online financial accounts are governed under Regulation E with regard to customer responsibility for loss resulting from such unauthorized transactions.

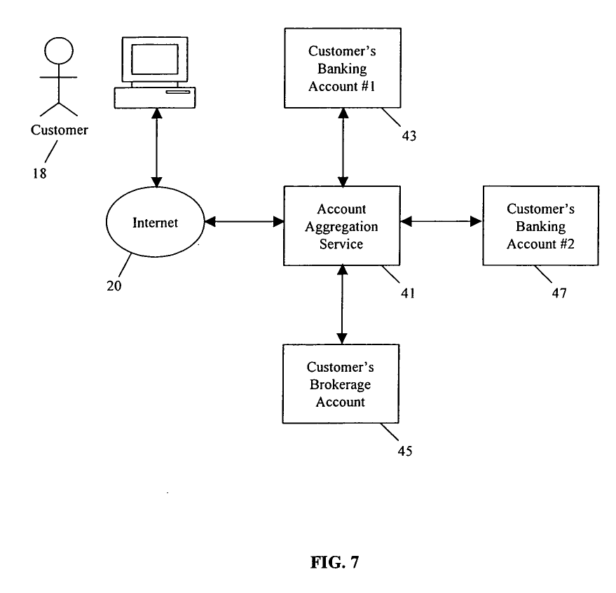

FIG. 7 is a schematic diagram which illustrates an example overview of key components and the flow of information between key components for an online account aggregation service covered under the policy utilized for an embodiment of the present invention. The non-account holding status of the online account aggregation service provider 41 is largely similar to that of the Internet bill management service 40 described earlier. However, an aspect of an embodiment of the present invention that is particularly critical to the online account aggregation service 41 is that the present invention provides a unique way for the aggregation service 41 to address security issues widely held by consumers. The reason for this being of particular import to an online aggregation service 41 is because to utilize such a service, the customer 18 must provide the online aggregation service 41 with all of the customer's passwords and codes so that the aggregation service 41 can gain online access to the customers accounts. Therefore, a security breach at the aggregation service 41 could expose the customer's entire online account portfolio, and addressing this security concern held by potential customers is of great importance to providers of online account aggregation services.

The account aggregation service industry is considered to be one of significant importance because of the benefit of providing the customer 18 with the ease of one stop viewing of multiple disparate accounts.

The account aggregation service aspect for an embodiment of the present invention involves modification of the Internet banking aspect in order to fit the nature of an account aggregation service 41. For example, the account aggregation service 41 is not necessarily the account holder, and more than one account, such as the customer's bank account 43 and the customer's brokerage account 45, is involved. Thus, the account aggregation aspect of an embodiment of the present invention involved modification of certain policy terms and conditions in order to accommodate the account aggregation aspect. However, ultimately the advertising benefit is the same intended benefit as with other aspects of the present invention, which provides, for example, a differentiating feature that promotes the business plan of the account aggregation service provider 41 by addressing the concern of using an account aggregation service 41 that requires the customer 18 to surrender multiple passwords to the accounts they wish to aggregate.

Regulation E, Section 205.3(c), provides that electronic funds transfer does not include securities and commodities transfers. Specifically, Regulation E does not apply to transaction instructions to a broker to buy or sell securities. However, Regulation E does apply to the use of a remote banking system that accesses a securities or commodities account such as a money market mutual fund and that the customer uses for purchasing goods or services or for obtaining cash. Therefore, Regulation E applies to a securities account when used, for example, for bill payment services. As the bill management service policy utilized for an embodiment of the present invention covers loss of money, the policy responds to an unauthorized bill payment under the aforementioned securities account in the same manner that the policy responds to such a transaction within a traditional checking account. However, Regulation E would not respond to an unauthorized buy or sell order for securities. Likewise, coverage under the policy does not apply to an unauthorized buy or sell order for securities.

The coverage under the policy utilized for an embodiment of the present invention provides the bill management service 40 or online account aggregation service 41 with the ability to reduce consumer concerns over the security of online financial transactions. Further, the protection provided by the policy adds a unique feature to the bill management service 40 or online account aggregation service 41. For example, the limit of coverage applies separately to each natural person customer of the bill management service 40 or online account aggregation service 41 with no aggregate limitation, should a single loss impact more than one customer. Any customers enrolled to the bill management service 40 or online account aggregation service 41 during the policy period are covered automatically with no mid-term charge during the policy period. In addition to unauthorized funds transfers, the coverage includes losses for resulting overdraft and merchant-assessed returned check fees and loss of interest income. Further, the bill management service 40 or online account aggregation service 41 is able to promote the protection within its website and with links to other websites.

An important benefit of the funds transfer aspect of the policy utilized for an embodiment of the present invention is that the bill management service 40 or online account aggregation service 41 is able to advertise to customers and potential customers that if they use the particular bill management service 40, or online account aggregation service 41, they have protection that they would not have if they used another service provider's bill management 40 or account aggregation service 41. An advantage from the underwriter's perspective is that once the protection program is implemented for one service provider, its competitors will likely want to make the same protection available for their own customers, in order to remain competitive.

Another aspect of the present invention provides, for example, identity theft expense protection 14 in the policy utilized for an embodiment of the invention. With the rapid expansion of electronic commerce and the frequent use of social security numbers and other personal identity information in everyday purchase transactions, crimes involving theft of one's identity have increased dramatically. Once identity theft occurs, there can be a substantial cost involved in restoring one's credit history. Credit bureaus, credit card companies, financial institutions and other entities need to be notified of the fraudulent activity, causing victims of identity theft to take time away from work and incur substantial expenses. The identity fraud expense coverage 14 pays an online customer 18 for expenses incurred by the online customer 18 as the direct result of any identity fraud commenced during the policy period and that is reported to the company during the policy period or within 30 days following the termination of the policy.

The identity theft expense protection aspect 14 likewise has the benefit, for example, for an online financial institution, of being able to market to its customers and potential customers that if they use the particular financial institution's online financial services, as a member benefit, they will receive protection from a major insurance company, which includes identify theft expense protection 14. Identity theft expense protection 14 provides coverage, for example, for the expenses that the online customer faces as a victim of the identity theft. Again, under the policy framework utilized for an embodiment of the present invention, identity theft expense protection 14 is an automatic benefit to people who sign up for a particular company's service. Thus, in addition to affording a marketing advantage by addressing security concerns about use of a financial institution's online service, an embodiment of the present invention provides an additional benefit of providing identify theft expense protection 14 for anyone who signs up for the service.

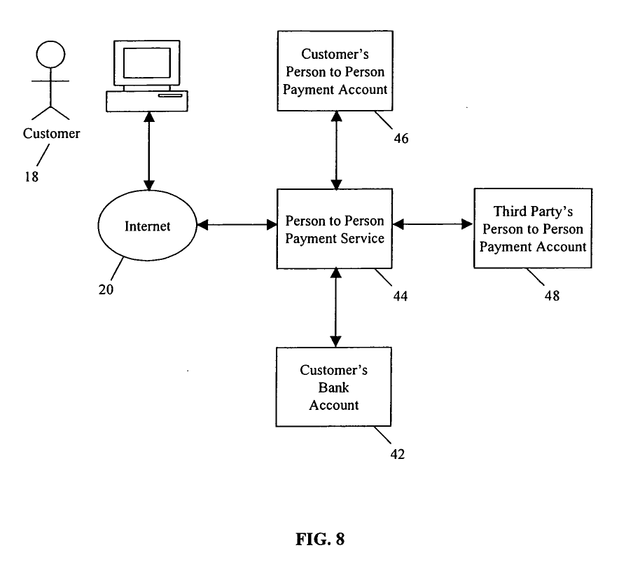

An additional aspect of an embodiment of the present invention involves person to person payments. FIG. 8 is a schematic diagram which illustrates an example overview of key components and the flow of information between key components for online person to person payment service covered under the policy utilized for an embodiment of the present invention. A person to person payment situation arises, for example, when a successful bidder on an Internet auction web site wants to make payment to someone who is a long distance away. Both parties have an interest in ways in which such payments can be made better and safer for the seller than simply sending and receiving a check. A person to person payment service 44 provides a secure framework for one party 18 to make payment to another party 48 without the parties having to worry, for example, about a check getting lost in the mail, or a check being returned for non-sufficient funds, and the like. An embodiment of the present invention addresses an Internet aspect of doing a person to person payment financial transaction.

There is, for example, a regulatory aspect involved in person to person payment services, as some person to person payment services involve payments from a customer's checking account 42, and others involve electronic funds transfers out of the customer's checking account 42. Thus, an aspect of an embodiment of the present invention also includes providing protection against loss, for example, by the customer 18 of the person to person payment service 44. A benefit of such protection for the person to person payment service 44 is that it can advertise to its customers and potential customers that if they use the particular person to person payment service 44, they will not have to worry about an unauthorized transaction in their online person to person payment service 44, because the payment service 44 has protection from a major insurance company that applies to losses that are normally a customer responsibility under applicable banking regulations.

The person to person payment service market is one of the most rapidly expanding segments for electronic payments, and the development of an infrastructure for person to person payments over the Internet is important, because it facilitates some of the most significant business sides of the Internet. For example, Internet auction websites are among the most visited web sites on the Internet, and all involve person to person commerce or pure commerce between individuals, although some businesses are involved as well. As part of this commerce, there must be a suitable way for people to pay each other. Previously, people were not able to receive and make credit card payments to each other, which was a weak link of Internet auctions. The issue was how a buyer can pay a seller so that the seller does not take a credit risk, and the buyer does not take a risk of the buyer's check getting lost in the mail.

As a result of the need created by these auction services and other online services, the person to person payment service was developed. Such service enables a buyer, through the buyer's credit card and through the use of e-mail, to make essentially a credit card transaction in which value is taken from the buyer's credit card and put into a person to person payment account 46 at a third party person to person payment service 44. Value can then be taken from the person to person payment account 46 and sent to a different account 48 within the person to person payment service 44. The person who is the seller then receives payment and delivers the auction item or other item being sold to the buyer. As with online banking service 22, account aggregation service 41, and bill management service 40, there are risks for such an account that has Internet access.

As mentioned, while a credit card is sometimes used, a significant number of people use banking accounts for their person to person payment services. For example, a feature is set up by which money is taken out of the buyer's bank account 42, sent to the buyer's person to person payment account 46, and then moved to the designated seller's account 48. Thus, the buyer's bank account 42, as well as the buyer's person to person payment account 46, is opened up to the Internet 20 and all the accompanying risks, such as loss of a PIN or an unauthorized transaction. The policy utilized for an embodiment of the present invention provides a backstop of confidence to stand behind the online financial transaction service in the person to person payment aspect. In addition to online banking service 22, account aggregation service 41, and bill management service 40, the policy provides protection in the person to person payment services context. The person to person payment service 44 can provide its customers protection for any unauthorized transactions within its customers' person to person payments account 44 or within the customers' banking account 42 which is accessed via the person to person payment service 44.

The person to person payment service aspect for an embodiment of the present invention involves modification of the Internet banking aspect, in order to fit the nature of a person to person payment service 44. For example, the person to person service 44 is not necessarily the account holder, and more than one account, such as the customer's bank account 42 and person to person payment service account 46, is involved. Thus, the person to person payment aspect of an embodiment of the present invention involves modification of certain policy terms and conditions in order to accommodate the person to person payment aspect. However, ultimately the advertising benefit is the same intended benefit as with other aspects of the present invention, which provides, for example, a differentiating feature that promotes the business plan of the service provider.

The policy utilized for an embodiment of the present invention provides protection from unauthorized transactions against an online account of the customer 18 of a person-to-person payment service 44. Under applicable regulations, the extent of the customer's liability is largely determined by the customer's promptness in notifying the payment service 44, if an unauthorized third party has gained access to the customer's password or if a transfer or withdrawal in the customer's monthly statement is incorrect or unauthorized. Thus, notifying the payment service 44 quickly limits the customer's liability. The coverage provided by the policy responds to losses for which the customer 18 would normally have liability under applicable banking regulations, up to the coverage limit per loss.

For the person to person payments service coverage 16 under the policy utilized for an embodiment of the present invention, an account is a demand deposit, checking, savings or other customer asset account, other than an occasional or incidental credit balance in a credit plan, held by the master policy holder and established primarily for personal, family or household purposes. Under the person to person payments service policy, an insured person is any natural person who maintains an account with the master policy holder and for whom the master policy holder provides a remote banking communication system service. The master policy holder is the entity named in the policy declarations as the master policy holder. Further, under the person to person payments service policy, a remote banking communication system is any electronic system provided by the master policy holder for use by an insured person, which allows the insured person to send instructions, via a personal computer operating through telephone or similar communication lines, to the master policy holder for the purpose of allowing the insured person to transfer money to or from an account, or to pay bills electronically from a remote location.

In addition, for the person to person payments service coverage 16 under the policy utilized for an embodiment of the present invention, an unauthorized remote banking electronic funds transfer means the use, by a person or entity other than the insured person without actual authority to initiate such transfer or debit, of a remote banking communication system to transfer money from an account maintained by an insured person, or to debit any such account, from which transfer or debit the insured person receives no benefit. Under the person to person payments service policy, an account is a demand deposit, checking, savings or other customer asset account, established at a financial institution primarily for personal, family or household purposes, and to which the master policy holder is granted access by an insured person as part of the person-to-person financial transaction service arrangement between the insured person and the master policy holder, as well as the insured person's account with the service provider.

Further, under the person to person payments service coverage 16 of the policy utilized for an embodiment of the present invention policy, an insured person is any natural person who maintains an account, is a registered customer of the person to person payment service, and for whom the master policy holder provides a remote banking communication system service. Also under the person to person payments service policy, a remote banking communication system is limited to the person-to-person financial transaction service. An important aspect of the person to person payment service policy is that the person to person payment service 44 is able to advertise to its customers and prospective customers that the protection benefit is provided free to its customers, that it is provided by a reputable insurance company, and that the coverage applies separately to every customer. A further aspect of the person to person payment service coverage 16 is that the protection can apply from first dollar with no deductible.

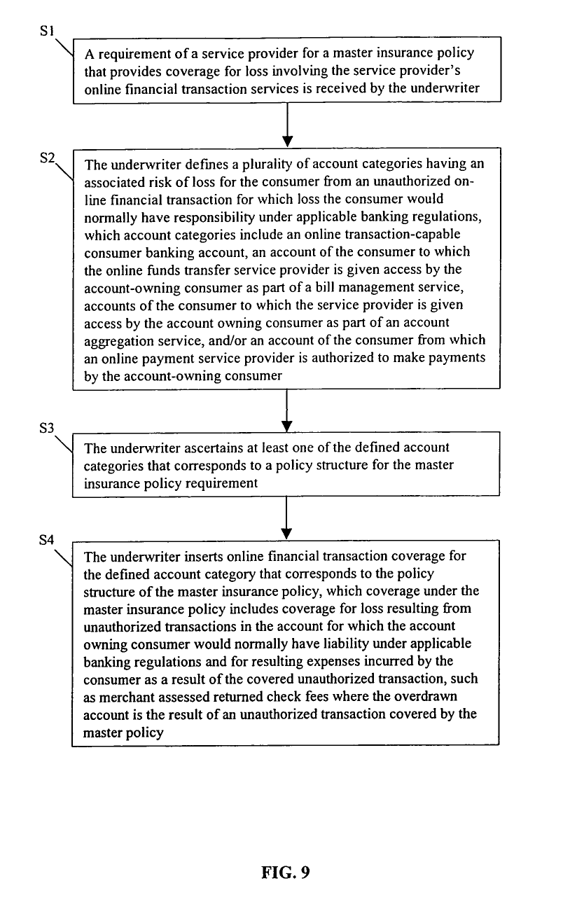

FIG. 9 is a flow chart which illustrates an example of the process of insuring against loss resulting from unauthorized transactions in connection with the use by a consumer 18 of an online service that provides online financial transactions, according to the method and system for an embodiment of the present invention. Referring to FIG. 9, at S1, a requirement of the service provider for a master insurance policy that provides coverage for loss involving the service provider's online financial transaction services is received by an underwriter. At S2, the underwriter defines a plurality of account categories having an associated risk of loss for the consumer 18 from an unauthorized online financial transaction, for which loss the consumer would normally have responsibility under applicable banking regulations, the account categories including at least one of an online transaction-capable consumer banking account 10, an account of the consumer to which the online funds transfer service provider is given access by the account-owning consumer 18 as part of a bill management service 12, accounts of the consumer 18 to which the service provider is given access by the account-owning consumer 18 as part of an account aggregation service 17, and an account of the consumer 18 from which an online payment service 16 is authorized to make payments by the account-owning consumer 18.

Referring further to FIG. 9, at S3, the underwriter ascertains at least one of the defined account categories that corresponds to a policy structure for the master insurance policy requirement. At S4, the underwriter inserts online financial transaction coverage for the defined account category that corresponds to the policy structure of the master insurance policy, which coverage under the master insurance policy includes coverage for loss resulting from unauthorized transactions in the account for which the account-owning consumer 18 would normally have liability under applicable banking regulations and for resulting expenses incurred by the consumer 18 as a result of the covered unauthorized transaction, such as merchant assessed returned check fees where such overdrawn account is the result of an unauthorized transaction covered by the subject master policy.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method of providing insurance against loss resulting from unauthorized transactions in connection with use by a consumer of an online financial transaction service, comprising:
receiving a requirement for a policy structure for a master insurance policy that provides coverage for loss relating to use by the consumer of at least one online financial transaction service;
defining a plurality of account categories having an associated risk of loss for the consumer resulting from an unauthorized transaction relating to the online financial transaction service for which loss the consumer would normally have responsibility under applicable banking regulations;
ascertaining at least one of the defined account categories that corresponds to the requirement for the policy structure for the master insurance policy; and
inserting online financial transaction coverage for the defined account category that corresponds to the policy structure of the master insurance policy.

2. The method of claim 1, wherein receiving the requirement further comprises receiving the requirement from a service provider of at least one online financial transaction service selected from a group of online financial transaction services consisting of an online banking service, an online bill management service, an account aggregation service, and an online person to person payment service.

3. The method of claim 1, wherein receiving the requirement further comprises receiving the requirement for the policy structure for the master insurance policy that provides coverage for loss relating to use by the consumer of at least one online financial transaction service selected from a group of online financial transaction services consisting of an online banking service, an online bill management service, an account aggregation service, and an online person to person payment service.

4. The method of claim 1, wherein defining the account categories further comprises defining account categories consisting of at least one of a banking account of the consumer capable of online transactions, an account of the consumer to which an online funds transfer service provider is given access by the consumer as part of a bill management service, accounts of the consumer to which the service provider is given access by the account-owning consumer as part of an account aggregation service, and an account of the consumer from which an online payment service provider is authorized by the consumer to make payments.

5. The method of claim 1, wherein defining the account categories further comprises defining account categories having the associated risk of loss for the consumer for which loss the consumer would normally have responsibility that is imposed in a plurality of tiers of consumer liability under applicable banking regulations.

6. The method of claim 5, wherein defining the account categories further comprises defining account categories having the associated risk of loss for the consumer for which loss the consumer would normally have responsibility that is imposed in three tiers of consumer liability under applicable banking regulations.

7. The method of claim 6, wherein defining the account categories further comprises defining account categories having the associated risk of loss for the consumer for which loss the consumer would normally have responsibility that is imposed in a $50 tier, a $500 tier, and an unlimited tier of consumer liability under applicable banking regulations

8. The method of claim 1, wherein ascertaining the at least one defined account category further comprises ascertaining at least one defined account category selected from a group of account categories consisting of a banking account of the consumer capable of online transactions, an account of the consumer to which an online funds transfer service provider is given access by the consumer as part of a bill management service, accounts of the consumer to which the service provider is given access by the account-owning consumer as part of an account aggregation service, and an account of the consumer from which an online payment service provider is authorized by the consumer to make payments.

9. The method of claim 1, wherein inserting online financial transaction coverage further comprises inserting at least one online financial transaction coverage selected from a group of online financial transaction coverages consisting of coverage for loss resulting from unauthorized transactions in the account for which the consumer would normally have liability under applicable banking regulations, coverage for expenses incurred by the consumer as a result of a covered unauthorized transaction in the account for which the consumer would normally have liability under applicable banking regulations, and coverage for expense incurred by the online consumer as the direct result of an identity fraud.

10. The method of claim 9, wherein inserting online financial transaction coverage for expenses incurred by the consumer as a result of a covered unauthorized transaction further comprises providing coverage to the consumer for a merchant-assessed returned check fee on an overdrawn account of the consumer as a result of an unauthorized transaction covered by the master insurance policy.

11. A system for providing insurance against loss resulting from unauthorized transactions in connection with use by a consumer of an online financial transaction service, comprising:
means for receiving a requirement for a policy structure for a master insurance policy that provides coverage for loss relating to use by the consumer of at least one online financial transaction service;
means for defining a plurality of account categories having an associated risk of loss for the consumer resulting from an unauthorized transaction relating to the online financial transaction service for which loss the consumer would normally have responsibility under applicable banking regulations;
means for ascertaining at least one of the defined account categories that corresponds to the requirement for the policy structure for the master insurance policy; and
means for inserting online financial transaction coverage for the defined account category that corresponds to the policy structure of the master insurance policy.

12. The system of claim 11, wherein the means for receiving the requirement further comprises means for receiving the requirement from a service provider of at least one online financial transaction service selected from a group of online financial transaction services consisting of an online banking service, an online bill management service, an account aggregation service, and an online person to person payment service.

13. The system of claim 11, wherein the means for receiving the requirement further comprises means for receiving the requirement for the policy structure for the master insurance policy that provides coverage for loss relating to use by the consumer of at least one online financial transaction service selected from a group of online financial transaction services consisting of an online banking service, an online bill management service, an account aggregation service, and an online person to person payment service.

14. The system of claim 11, wherein the means for defining the account categories further comprises means for defining account categories consisting of at least one of a banking account of the consumer capable of online transactions, an account of the consumer to which an online funds transfer service provider is given access by the consumer as part of a bill management service, accounts of the consumer to which the service provider is given access by the account-owning consumer as part of an account aggregation service, and an account of the consumer from which an online payment service provider is authorized by the consumer to make payments.

15. The system of claim 11, wherein the means for defining the account categories further comprises means for defining account categories having the associated risk of loss for the consumer for which loss the consumer would normally have responsibility that is imposed in a plurality of tiers of consumer liability under applicable banking regulations.

16. The system of claim 15, wherein the means for defining the account categories further comprises means for defining account categories having the associated risk of loss for the consumer for which loss the consumer would normally have responsibility that is imposed in three tiers of consumer liability under applicable banking regulations.

17. The system of claim 16, wherein the means for defining the account categories further comprises means for defining account categories having the associated risk of loss for the consumer for which loss the consumer would normally have responsibility that is imposed in a $50 tier, a $500 tier, and an unlimited tier of consumer liability under applicable banking regulations.

18. The system of claim 11, wherein the means for ascertaining the at least one defined account category further comprises means for ascertaining at least one defined account category selected from a group of account categories consisting of a banking account of the consumer capable of online transactions, an account of the consumer to which an online funds transfer service provider is given access by the consumer as part of a bill management service, accounts of the consumer to which the service provider is given access by the account-owning consumer as part of an account aggregation service, and an account of the consumer from which an online payment service provider is authorized by the consumer to make payments.

19. The system of claim 11, wherein the means for inserting online financial transaction coverage further comprises means for inserting at least one online financial transaction coverage selected from a group of online financial transaction coverages consisting of coverage for loss resulting from unauthorized transactions in the account for which the consumer would normally have liability under applicable banking regulations, coverage for expenses incurred by the consumer as a result of a covered unauthorized transaction in the account for which the consumer would normally have liability under applicable banking regulations, and coverage for expense incurred by the online consumer as the direct result of an identity fraud.

20. The system of claim 19, wherein the means for inserting online financial transaction coverage for expenses incurred by the consumer as a result of a covered unauthorized transaction further comprises means for providing coverage to the consumer for a merchant-assessed returned check fee on an overdrawn account of the consumer as a result of an unauthorized transaction covered by the master insurance policy.

21. A method of providing insurance against loss resulting from unauthorized transactions in connection with the use by a consumer of an online service that provides online financial transactions and which service is covered by the insurance, comprising:
receiving a master insurance policy by a service provider that provides coverage for loss involving the service provider's online financial transaction services as stipulated within the policy;
defining a plurality of account categories having an associated risk of loss for the consumer from an unauthorized online financial transaction, for which loss the consumer would normally have responsibility under applicable banking regulations, the account categories including at least one of an online transaction-capable banking account of the consumer, an account of the consumer to which a online funds transfer service provider is given access by the consumer as part of a bill management service, accounts of the consumer to which the service provider is given access by the account-owning consumer as part of an account aggregation service, and an account of the consumer from which an online payment service provider is authorized to make payments by the consumer;
ascertaining at least one of the defined account categories that corresponds to the policy structure for the master insurance policy issued to the service provider;
inserting online financial transaction coverages for the defined account category that correspond to the policy structure of the master insurance policy, which coverage includes coverage for loss resulting from unauthorized transactions in the account for which the consumer would normally have liability under applicable banking regulations and for resulting expenses incurred by said consumer as a result of the covered unauthorized transaction.

22. A method of providing insurance against loss in connection with an online financial transaction, comprising:
receiving a policy requirement for a master online financial transaction insurance policy;
defining a plurality of account categories having an associated risk of loss for an account holder from an online financial transaction with the account that is normally an account holder responsibility under applicable banking regulations, the account categories including at least one of an online bank account of the account holder, an account of the account holder to which a funds transfer service provider is given access as part of a bill management service, accounts of the consumer to which the service provider is given access by the account-owning consumer as part of an account aggregation service, and an account of the account holder from which an online payment service provider is authorized to make payments;
identifying at least one of the defined account categories that corresponds to the policy requirement for the online financial transaction insurance policy; and
inserting online financial transaction coverage for the defined account category in the master online financial transaction insurance policy that corresponds to the policy requirement, which coverage includes losses resulting from unauthorized transactions in the account for which the account holder would normally have liability under applicable banking regulations and expenses of the account holder in connection with unauthorized transactions in the account for which the account holder would normally have liability under applicable banking regulations.
